(19) United States
(12) Patent Application Publication
(10) Pub. No.: US 2013/0040183 A1
(43) Pub. Date: Feb. 14, 2013

(54) ELECTROCHEMICAL CELLS

(71) Applicants: Klaus LEITNER, Ludwigshafen (DE); Arnd Garsuch, Ludwigshafen (DE); Oliver Gronwald, Frankfurt (DE); Martin Schulz-Dobrick, Mannheim (DE)

(72) Inventors: Klaus LEITNER, Ludwigshafen (DE); Arnd Garsuch, Ludwigshafen (DE); Oliver Gronwald, Frankfurt (DE); Martin Schulz-Dobrick, Mannheim (DE)

(73) Assignee: BASF SE, Ludwigshafen (DE)

(21) Appl. No.: 13/567,389

(22) Filed: Aug. 6, 2012

Related U.S. Application Data
(60) Provisional application No. 61/515,993, filed on Aug. 8, 2011.

(51) Int. Cl. H01M 10/02; H01M 4/505; H01M 6/00; H01M 2/16; H01M 4/62; H01M 4/583; H01M 4/485; H01M 4/525

(52) U.S. Cl. 429/144; 429/231.1; 429/224; 429/221; 429/223; 429/217; 29/623.1

(57) ABSTRACT

The present invention relates to electrochemical cells comprising
(A) at least one cathode comprising at least one lithium ion-containing transition metal compound,
(B) at least one anode,
(C) at least one layer comprising
   (a) at least one lithium- and oxygen-containing, electrochemically active transition metal compound, and
   (b) optionally at least one binder, and
(D) at least one electrically nonconductive, porous and ion-pervious layer positioned between cathode (A) and layer (C), and at least one electrically nonconductive, porous and ion-pervious layer positioned between anode (B) and layer (C).

The present invention further relates to the use of inventive electrochemical cells, to the production thereof, and to a specific separator for the separation of a cathode and an anode in an electrochemical cell.

The present invention relates to electrochemical cells comprising
(A) at least one cathode comprising at least one lithium ion-containing transition metal compound,
(B) at least one anode,
(C) at least one layer comprising
   (a) at least one lithium- and oxygen-containing, electrochemically active transition metal compound, and
   (b) optionally at least one binder, and
(D) at least one electrically nonconductive, porous and ion-pervious layer positioned between cathode (A) and layer (C), and at least one electrically nonconductive, porous and ion-pervious layer positioned between anode (B) and layer (C).

The present invention further relates to the use of inventive electrochemical cells, to the production thereof, and to a specific separator for the separation of a cathode and an anode in an electrochemical cell.

Storing energy has long been a subject of growing interest. Electrochemical cells, for example batteries or accumulators, can serve to store electrical energy. As of recently, what are called lithium ion batteries have attracted particular interest. They are superior to the conventional batteries in several technical aspects. For instance, they can be used to generate voltages unobtainable with batteries based on aqueous electrolytes.

In this context, an important role is played by the materials from which the electrodes are made, and especially the material from which the cathode is made.

In many cases, lithium-containing mixed transition metal oxides are used, especially lithium-containing nickel-cobalt-manganese oxides with layer structure, or manganese-containing spinels which may be doped with one or more transition metals. However a problem with many batteries remains that of cycling stability, which is still in need of improvement. Specifically in the case of those batteries which comprise a comparatively high proportion of manganese, for example in the case of electrochemical cells with a manganese-containing spinel electrode and a graphite anode, a severe loss of capacity is frequently observed within a relatively short time. In addition, it is possible to detect deposition of elemental manganese on the anode in cases where graphite anodes are selected as counterelectrodes. It is believed that these manganese nuclei deposited on the anode, at a potential of less than 1V vs. Li/Li+, act as a catalyst for a reductive decomposition of the electrolyte. This is also thought to involve irreversible binding of lithium, as a result of which the lithium ion battery gradually loses capacity.

WO 2009/033627 discloses a ply which can be used as separator for lithium ion batteries. It comprises a nonwoven and particles which are intercalated into the nonwoven and consist of organic polymers and possibly partly of inorganic material. Such separators can avoid short circuits caused by metal dendrites. However, WO 2009/033627 does not disclose any long-term cycling experiments.

WO 2011/024149 discloses lithium ion batteries which comprise an alkali metal such as lithium between cathode and anode, which acts as a scavenger of unwanted by-products or impurities. Both in the course of production of secondary battery cells and in the course of later recycling of the spent cells, suitable safety precautions have to be taken due to the presence of highly reactive alkali metal.

It was thus an object of the present invention to provide electrical cells which have an improved lifetime and in which, even after several cycles, no deposition of elemental manganese is observed, or in the course of whose production it is possible to use a scavenger which has a lower level of safety problems than the alkali metals and prolongs the lifetime of the cell to the desired degree.

This object is achieved by an electrochemical cell defined at the outset, which comprises
(A) at least one cathode comprising at least one lithium ion-containing transition metal compound,
(B) at least one anode,
(C) at least one layer comprising
   (a) at least one lithium- and oxygen-containing, electrochemically active transition metal compound, and
   (b) optionally at least one binder, and
(D) at least one electrically nonconductive, porous and ion-pervious layer positioned between cathode (A) and layer (C), and at least one electrically nonconductive, porous and ion-pervious layer positioned between anode (B) and layer (C).

The cathode (A) comprises at least one lithium ion-containing transition metal compound, for example the transition metal compounds LiCoO₂, LiFePO₄ or lithium-manganese spinel which are known to the person skilled in the art in lithium ion battery technology. The cathode (A) preferably comprises, as the lithium ion-containing transition metal compound, a lithium ion-containing transition metal oxide which comprises manganese as the transition metal.

Lithium ion-containing transition metal oxides which comprise manganese as the transition metal are understood in the context of the present invention to mean not only those oxides which have at least one transition metal in cationic form, but also those which have at least two transition metal oxides in cationic form. In addition, in the context of the present invention, the term “lithium ion-containing transition metal oxides” also comprises those compounds which—as well as lithium—comprise at least one non-transition metal in cationic form, for example aluminum or calcium.

In a particular embodiment, manganese may occur in cathode (A) in the formal oxidation state of +4. Manganese in cathode (A) more preferably occurs in a formal oxidation state in the range from +3.5 to +4.

Many elements are ubiquitous. For example, sodium, potassium and chloride are detectable in certain very small proportions in virtually all inorganic materials. In the context of the present invention, proportions of less than 0.1% by weight of cations or anions are disregarded. Any lithium ion-containing mixed transition metal oxide comprising less than 0.1% by weight of sodium is thus considered to be sodium-free in the context of the present invention. Correspondingly, any lithium ion-containing mixed transition metal oxide comprising less than 0.1% by weight of sulfate ions is considered to be sulfate-free in the context of the present invention.

In one embodiment of the present invention, lithium ion-containing transition metal oxide is a mixed transition metal oxide comprising not only manganese but at least one further transition metal.

In one embodiment of the present invention, lithium ion-containing transition metal compound is selected from manganese-containing lithium iron phosphates and preferably from manganese-containing spinels and manganese-containing transition metal oxides with layer structure, especially manganese-containing mixed transition metal oxides with layer structure.

In one embodiment of the present invention, lithium ion-containing transition metal compound is selected from those compounds having a superstoichiometric proportion of lithium.

In one embodiment of the present invention, manganese-containing spinels are selected from those of the general formula (I)

LiₐM¹_{b}Mn_{3-a-b}O_{4-d} (I)

where the variables are each defined as follows:

0.9≦a≦1.3, preferably 0.95≦a≦1.15,

0≦b≦0.6, for example 0.0 or 0.5,

where, in the case that M¹ selected=Ni, preferably: 0.4≦b≦0.55,

−0.1≦d≦0.4, preferably 0≦d≦0.1.

M¹ is selected from one or more elements selected from Al, Mg, Ca, Na, B, Mo, W and transition metals of the first period of the Periodic Table of the Elements. M¹ is preferably selected from Ni, Co, Cr, Zn, Al, and M¹ is most preferably Ni.

In one embodiment of the present invention, manganese-containing spinels are selected from those of the formula LiNi_{0.5}Mn_{1.5}O_{4-d} and LiMn₂O₄.

In another embodiment of the present invention, manganese-containing transition metal oxides with layer structure are selected from those of the formula (II)

Li₁₊ₜM²₁₋ₜO₂ (II)

where the variables are each defined as follows:

0≦t≦0.3 and

M² is selected from Al, Mg, B, Mo, W, Na, Ca and transition metals of the first period of the Periodic Table of the Elements, the transition metal or at least one transition metal being manganese.

In one embodiment of the present invention, at least 30 mol % of M² is selected from manganese, preferably at least 35 mol %, based on the total content of M².

In one embodiment of the present invention, M² is selected from combinations of Ni, Co and Mn which do not comprise any further elements in significant amounts.

In another embodiment, M² is selected from combinations of Ni, Co and Mn which comprise at least one further element in significant amounts, for example in the range from 1 to 10 mol % of Al, Ca or Na.

In one embodiment of the present invention, manganese-containing transition metal oxides with layer structure are selected from those in which M² is selected from Ni_{0.33}Co_{0.33}Mn_{0.33}, Ni_{0.5}Co_{0.2}Mn_{0.3}, Ni_{0.4}Co_{0.3}Mn_{0.4}, Ni_{0.4}Co_{0.2}Mn_{0.4} and Ni_{0.45}Co_{0.10}Mn_{0.45}.

In one embodiment, lithium-containing transition metal oxide is in the form of primary particles agglomerated to spherical secondary particles, the mean particle diameter (D50) of the primary particles being in the range from 50 nm to 2 μm and the mean particle diameter (D50) of the secondary particles being in the range from 2 μm to 50 μm.

Cathode (A) may comprise one or further constituents. For example, cathode (A) may comprise carbon in a conductive polymorph, for example selected from graphite, carbon black, carbon nanotubes, graphene or mixtures of at least two of the aforementioned substances.

In addition, cathode (A) may comprise one or more binders, for example one or more organic polymers. Suitable binders are, for example, organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene, especially styrene-butadiene copolymers. Polypropylene is also suitable. Polyisoprene and polyacrylates are additionally suitable. Particular preference is given to polyacrylonitrile.

Polyacrylonitrile is understood in the context of the present invention to mean not only polyacrylonitrile homopolymers, but also copolymers of acrylonitrile with 1,3-butadiene or styrene. Preference is given to polyacrylonitrile homopolymers.

In the context of the present invention, polyethylene is understood to mean not only homopolyethylene but also copolymers of ethylene which comprise at least 50 mol % of ethylene in copolymerized form and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is understood to mean not only homopolypropylene but also copolymers of propylene which comprise at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is understood to mean not only homopolymers of styrene but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binders are selected from those (co)polymers which have a mean molecular weight M_{w} in the range from 50 000 to 1 000 000 g/mol, preferably to 500 000 g/mol.

Binders may be crosslinked or uncrosslinked (co)polymers.

In a particularly preferred embodiment of the present invention, binders are selected from halogenated (co)polymers, especially from fluorinated (co)polymers. Halogenated or fluorinated (co)polymers are understood to mean those (co)polymers comprising, in copolymerized form, at least one (co)monomer having at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In addition, cathode (A) may have further constituents customary per se, for example an output conductor, which may be configured in the form of a metal wire, metal grid, metal mesh, expanded metal, metal sheet or metal foil. Suitable metal foils are especially aluminum foils.

In one embodiment of the present invention, cathode (A) has a thickness in the range from 25 to 200 μm, preferably from 30 to 100 μm, based on the thickness without output conductor.

Inventive electrochemical cells further comprise at least one anode (B).

In one embodiment of the present invention, anode (B) can be selected from anodes composed of carbon and anodes comprising Sn or Si. Anodes composed of carbon can be selected, for example, from hard carbon, soft carbon, graphene, graphite, and especially graphite, intercalated graphite and mixtures of two or more of the aforementioned carbons. Anodes comprising Sn or Si can be selected, for example, from nanoparticulate Si or Sn powder, Si or Sn fibers, carbon-Si or carbon-Sn composite materials, and Si-metal or Sn-metal alloys.

Anode (B) may have one or more binders. The binder selected may be one or more of the aforementioned binders specified in the context of the description of cathode (A).

In addition, anode (B) may have further constituents customary per se, for example an output conductor which may be configured in the form of a metal wire, metal grid, metal mesh, expanded metal, or metal foil or metal sheet. Suitable metal foils are especially copper foils.

In one embodiment of the present invention, anode (B) has a thickness in the range from 15 to 200 μm, preferably from 30 to 100 μm, based on the thickness without output conductor.

Inventive electrochemical cells further comprise (C) at least one layer, also called layer (C) for short, which comprises (a) at least one lithium- and oxygen-containing, electrochemically active transition metal compound, also called transition metal compound (a) for short, and (b) optionally at least one binder, also called binder (b) for short.

Lithium- and oxygen-containing, electrochemically active transition metal compounds (a) are known as such. More particularly, the transition metal compounds (a) are those materials which are already used as electrode materials either in the cathode or in the anode in electrochemical cells.

In a preferred embodiment of the present invention, the lithium- and oxygen-containing, electrochemically active transition metal compound (a) from layer (C) is a particulate material. Transition metal compounds (a) may, in the context of the present invention, have a mean particle diameter (D50) in the range from 0.05 to 100 μm, preferably 2 to 50 μm.

In a preferred embodiment of the present invention, the lithium- and oxygen-containing, electrochemically active transition metal compound (a) from layer (C) is a compound selected from the group consisting of lithium titanates of the formula Li₄₊ₓTi₅O₁₂ where x is a numerical value from >0 to 3, lithium iron phosphate, lithium nickel cobalt manganese oxides, lithium nickel cobalt aluminum oxides, lithium manganese oxides and mixtures thereof, especially a lithium titanate of the formula Li₄₊ₓTi₅O₁₂ in which x is a numerical value from >0 to 3.

In a further preferred embodiment of the present invention, the lithium- and oxygen-containing, electrochemically active transition metal compound (a) from layer (C) is a compound which, in an electrochemical cell, has a potential difference between 1 and 5 V, preferably between 1 and 4 V, more preferably between 1 and 2.5 V, especially between 1 and 1.8 V, with respect to Li/Li⁺.

In one embodiment of the present invention, binder (b) is selected from those binders as described in connection with binders for the cathode(s) (A).

In a preferred embodiment of the present invention, layer (C) comprises a binder (b) selected from the group of polymers consisting of polyvinyl alcohol, styrene-butadiene rubber, polyacrylonitrile, carboxymethylcellulose and fluorinated (co)polymers, especially selected from styrene-butadiene rubber and fluorinated (co)polymers.

In one embodiment of the present invention, binder (b) and binder for cathode and for anode, if present, are each the same.

In another embodiment, binder (b) differs from binder for cathode (A) and/or binder for anode (B), or binder for anode (B) and binder for cathode (A) are different.

In one embodiment of the present invention, layer (C) has a mean thickness in the range from 0.1 μm to 250 μm, preferably from 1 μm to 50 μm and more preferably from 9 μm to 35 μm.

Layer (C) may, as well as the transition metal compound (a) and the optional binder (b), have further constituents, for example support materials such as fibers or nonwovens which ensure improved stability of layer (C), without impairing the necessary porosity and ion perviosity thereof.

Inventive electrochemical cells further comprise (D) at least one electrically nonconductive, porous and ion-pervious layer positioned between cathode (A) and layer (C), and at least one electrically nonconductive, porous and ion-pervious layer positioned between anode (B) and layer (C). Thus, an inventive electrochemical cell comprises at least two electrically nonconductive, porous and ion-pervious layers, which are also referred to in the context of the present invention for short as layers (D) in the plural or layer (D) in the singular.

In principle, the layers (D) may be the same or different, any difference between two layers (D) being based, for example, on the chemical composition thereof or the specific material properties thereof, such as density, porosity or spatial dimensions, for example thickness, though the enumeration of the potential differences is not conclusive.

Electrically nonconductive, porous and ion-pervious layers are known as such and are already being used, for example, as simple separators in electrochemical cells between cathode and anode.

Layer (D) may, for example, be a nonwoven which may be inorganic or organic in nature, or a porous polymer layer, for example a polyolefin membrane, especially a polyethylene or polypropylene membrane. Polyolefin membranes may in turn be formed from one or more layers. Layer (D) is preferably a nonwoven.

Examples of organic nonwovens are polyester nonwovens, especially polyethylene terephthalate nonwovens (PET nonwovens), polybutylene terephthalate nonwovens (PBT nonwovens), polyimide nonwovens, polyethylene and polypropylene nonwovens, PVdF nonwovens and PTFE nonwovens.

Examples of inorganic nonwovens are glass fiber nonwovens and ceramic fiber nonwovens.

The layer (C) present in the inventive electrochemical cell, or the structural unit consisting of layer (C) and two layers (D) aligned in parallel, may also be produced as a semifinished product independently of the construction of the inventive electrochemical cell, and be incorporated later into an electrochemical cell by a battery manufacturer as a finished separator or part of the separator between cathode and anode.

The present invention therefore also further provides a flat separator of layered structure for the separation of a cathode and an anode in an electrochemical cell, comprising
(C) at least one layer, called layer (c) for short, comprising
   (a) at least one lithium- and oxygen-containing, electrochemically active transition metal compound, called transition metal compound (a) for short, and
   (b) optionally at least one binder, called binder (b) for short, and
(D) two layers which are aligned parallel to one another and are electrically nonconductive, porous and ion-pervious, called layers (D) for short, layer (C) being between the two layers (D).

The present invention likewise also provides for the use of a layer (C) comprising
(a) at least one lithium- and oxygen-containing, electrochemically active transition metal compound, called transition metal compound (a) for short, and
(b) optionally at least one binder, called binder (b) for short,

as a constituent of a separator which ensures the separation of a cathode and an anode in an electrochemical cell.

In the context of the present invention, the expression “flat” means that the separator described, a three-dimensional body, is smaller in one of its three spatial dimensions (extents), namely the thickness, with respect to the two other dimensions, the length and width. Typically, the thickness of the separator is less than the second-greatest dimension at least by a factor of 5, preferably at least by a factor of 10, more preferably at least by a factor of 20.

Preferred embodiments with regard to layer (C) and the constituents present therein, namely the transition metal compound (a) and any binder (b) present, and with regard to layers (D), are identical to those described above in connection with the inventive electrochemical cell.

Since the separators are flat, they can not only be incorporated as flat layers between cathode and anode, but can also, as required, be rolled up, wound up or folded as desired.

In one embodiment of the present invention, flat separator of layered structure has a thickness in the range from 5 μm to 250 μm, preferably from 10 μm to 50 μm.

In a particularly preferred embodiment, the inventive separator comprises, in layer (C), as a transition metal compound (a), lithium titanate of the formula Li₄₊ₓTi₅O₁₂ in which x is a numerical value from >0 to 3, and, as binder (b), a styrene-butadiene rubber or a fluorinated (co)polymer, and the two layers (D) are each a nonwoven, especially a nonwoven produced from an organic polymer.

The production of separators with a (D)/(C)/(D) layer structure is known in principle and is described, for example, in WO 2009/033627. The inventive flat separator of layered structure can be produced, for example, in the form of continuous belts which are processed further by the battery manufacturer, especially to give an inventive electrochemical cell.

Inventive electrochemical cells or the inventive separator comprise(s), in a particularly preferred embodiment, as the transition metal compound (a), lithium titanate of the formula Li₄₊ₓTi₅O₁₂ in which x is a numerical value from >0 to 3. In order to generate a lithium titanate of the formula Li₄₊ₓTi₅O₁₂ with a numerical value from >0 to 3, it is possible to further enrich lithium titanate of the formula Li₄Ti₅O₁₂ with lithium, in other words to formally reduce the oxidation number of the titanium. This process is called lithiation in the context of the present invention. The lithiation of the lithium titanate of the formula Li₄Ti₅O₁₂ may precede or follow the construction of the inventive electrochemical cells or of the inventive separator. Means of lithiation of the lithium titanate of the formula Li₄Ti₅O₁₂ are, for example:

(i) electrochemical reduction of Li₄Ti₅O₁₂ against a lithium anode,

(ii) reaction of Li₄Ti₅O₁₂ with elemental lithium, and

(iii) reaction of Li₄Ti₅O₁₂ with a lithium alkyl or lithium aryl.

Means (i) can be implemented, for example, by arranging Li₄Ti₅O₁₂ as an electrode in a half-cell with lithium as the counterelectrode, and then applying a current until the potential falls below 1.5 V with respect to Li/Li⁺.

In means (ii), as elemental lithium, it is possible, for example, to mix a lithium powder such as “SMLP®” from FMC with Li₄Ti₅O₁₂ in powder form, or Li₄Ti₅O₁₂ is coated with lithium by means of gas phase processes such as CVD or PVD, for example by vapor deposition of lithium at, for example, 600° C. under reduced pressure. As soon as the Li/Li₄Ti₅O₁₂ mixture has contact with an electrolyte, there is automatic lithiation of the Li₄Ti₅O₁₂.

According to means (iii), the Li₄Ti₅O₁₂ can also be lithiated by reaction with a lithium alkyl or lithium aryl.

The present invention therefore also further provides a process for producing an electrochemical cell as described above, comprising
(A) at least one cathode comprising at least one lithium ion-containing transition metal compound,
(B) at least one anode,
(C) at least one layer comprising
   (a) at least one lithium titanate of the formula Li₄₊ₓTi₅O₁₂ in which x is a numerical value from >0 to 3, and
   (b) optionally at least one binder, and
(D) at least one electrically nonconductive, porous and ion-pervious layer positioned between cathode (A) and layer (C), and at least one electrically nonconductive, porous and ion-pervious layer positioned between anode (B) and layer (C),

comprising, as one of the process steps, the lithiation of Li₄Ti₅O₁₂ by a process step selected from the group of process steps consisting of:

(i) electrochemical reduction of Li₄Ti₅O₁₂ against a lithium anode,

(ii) reaction of Li₄Ti₅O₁₂ with elemental lithium, and

(iii) reaction of Li₄Ti₅O₁₂ with a lithium alkyl or lithium aryl.

Inventive electrochemical cells may also have constituents customary per se, for example conductive salt, nonaqueous solvent, and also cable connections and housing.

In one embodiment of the present invention, inventive electrochemical cells comprise at least one nonaqueous solvent which may be liquid or solid at room temperature and is preferably liquid at room temperature, and which is preferably selected from polymers, cyclic or noncyclic ethers, cyclic or noncyclic acetals, cyclic or noncyclic organic carbonates and ionic liquids.

Examples of suitable polymers are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably di-methyl- or -ethyl-end capped polyalkylene glycols.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

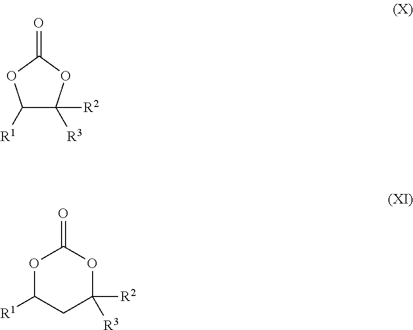

in which R¹, R² and R³ may be the same or different and are each selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

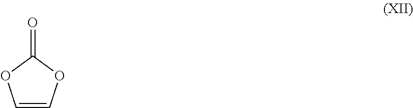

Preference is given to using the solvent(s) in what is called the anhydrous state, i.e. with a water content in the range from 1 ppm to 0.1% by weight, determinable, for example, by Karl Fischer titration.

Inventive electrochemical cells further comprise at least one conductive salt. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,

m=2 when X is selected from nitrogen and phosphorus, and

m=3 when X is selected from carbon and silicon.

Preferred conductive salts are selected from LiC(CF₃SO₂)₃, LiN(CF₃SO₂)₂, LiPF₆, LiBF₄, LiClO₄, and particular preference is given to LiPF₆ and LiN(CF₃SO₂)₂.

Inventive electrochemical cells further comprise a housing which may be of any shape, for example cuboidal or in the shape of a cylinder. In another embodiment, inventive electrochemical cells have the shape of a prism. In one variant, the housing used is a metal-plastic composite film processed as a pouch.

Inventive electrochemical cells give a high voltage of up to approx. 4.8 V and are notable for high energy density and good stability. More particularly, inventive electrochemical cells are notable for only a very small loss of capacity in the course of repeated cycling.

The present invention further provides for the use of inventive electrochemical cells in lithium ion batteries. The present invention further provides lithium ion batteries comprising at least one inventive electrochemical cell. Inventive electrochemical cells can be combined with one another in inventive lithium ion batteries, for example in series connection or in parallel connection. Series connection is preferred.

The present invention further provides for the use of inventive electrochemical cells as described above in automobiles, bicycles operated by electric motor, aircraft, ships or stationary energy stores.

The present invention therefore also further provides for the use of inventive lithium ion batteries in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The use of inventive lithium ion batteries in devices gives the advantage of prolonged runtime before recharging and a smaller loss of capacity in the course of prolonged runtime. If the intention were to achieve an equal run time with electrochemical cells with lower energy density, a higher weight for electrochemical cells would have to be accepted.

The invention is illustrated by the examples which follow, which do not, however, restrict the invention.

Figures in % are each based on % by weight, unless explicitly stated otherwise.

### I. Production of Inventive Separators Composed of Layer (C) and Two Layers (D)

### I.1 Production of an Inventive Separator (S.1)

Disks of diameter 13 mm were punched out of a glass fiber nonwoven (Whatman, thickness 260 μm), and they were dried in a drying cabinet at 120° C. for several hours. Thereafter, the glass fiber nonwoven disks were transferred to an argon-filled glovebox. Each glass fiber nonwoven disk was divided into two parts, such that one glass fiber nonwoven disk gave two glass fiber nonwoven disks each of thickness approx. 130 μm.

Lithium titanate (LTO-2, CHINA ELEMENT INTERNATIONAL LIMITED) was dried at 200° C. in a vacuum drying cabinet over a period of 16 hours. Thereafter, the fine powder was mixed in a weight ratio of 9:1 with polyvinylidene fluoride, commercially available as Kynar® FLEX 2801 from Arkema, and then N-methylpyrrolidone was added dropwise until a viscous paste was obtained. The viscous paste thus obtained was stirred over a period of 16 hours.

The paste thus obtained was knife-coated homogeneously onto a PET nonwoven, commercially available as “PES20” nonwoven from APODIS Filtertechnik OHG, and the LTO-coated nonwoven was dried at 120° C. in a drying cabinet for 2 hours. After drying, a nonwoven was obtained with an LTO coverage of in each case approx. 15 mg/cm². Thereafter, disks of diameter 13 mm were punched out and they were dried once again in a vacuum drying cabinet at 120° C. for 16 hours in order to obtain layer C.1.

Subsequently, the LTO-coated disk C.1 was transferred to an argon-filled glovebox and was placed in the manner of a sandwich between two glass fiber nonwoven disks in order to obtain separator S.1.

### I.2 Production of an Inventive Separator (S.2)

Experiment I.1 was repeated, except that layer C.1 was placed into a solution of butyllithium in hexane (Aldrich) in an argon-filled glovebox for 16 h in order to lithiate the LTO, in the course of which the originally white layer A.1 turned uniformly dark in color. Subsequently, layer C.1 was washed with hexane (anhydrous, Aldrich) and then diethylene carbonate (anhydrous, Aldrich) and dried at room temperature for 16 h to obtain layer (C.2). Layer C.2 was placed in the manner of a sandwich between two glass fiber nonwoven disks in order to obtain separator S.2.

### I.3 Production of an Inventive Separator (S.3)

Experiment I.1 was repeated, except that lithium iron phosphate (LFP from BASF) was now used in place of LTO to obtain layer C.3 or separator S.3.

### I.4 Production of an Inventive Separator (S.4)

Experiment I.1 was repeated, except that a 1:1 mixture (parts by weight) of LTO and LFP was now used in place of LTO to produce layer C.4 or obtain separator S.4.

### I.5 Production of an Inventive Separator (S.5)

Experiment I.1 was repeated, except that overlithiated layer oxide Li_{1.2}Ni_{0.22}Co_{0.12}Mn_{0.66}O₂ (BASF) was now used in place of LTO to obtain layer C.5 or separator S.5.

### I.6 Production of a Noninventive Separator (C-S.6)

The experiment from Example I.1 was repeated under the same conditions, except that the PET nonwoven was not coated with LTO but rather used in uncoated form to obtain layer C.6 and consequently comparative separator C-S.6.

### I.7 Production of a Noninventive Separator (C-S.7)

The experiment from Comparative Example I.6 was repeated under the same conditions, except that a separator as described in publication WO2004/021475 was now used in place of the PET nonwoven (layer C.6) to obtain layer C.7 and consequently comparative separator C-S.7.

### I.8 Production of a Noninventive Separator (C-S.8)

Experiment I.1 was repeated in altered form, in that lithium powder (Aldrich) was now used in place of LTO to obtain layer C.8 or comparative separator C-S.8. A viscous suspension was produced from the lithium powder with dioxolane (Aldrich) and Kynar-flex (Arkema) (Li:PVdF weight ratio=4:1) and was stirred overnight. The PET nonwoven was coated with the lithium/DOL/Kynarflex dispersion by knife-coating in an argon-flooded glovebox. Drying was effected at 40° C. under reduced pressure overnight.

### II. Production of Electrochemical Cells and Testing Thereof

The following electrodes were always used:

Cathode (A.1): a lithium-nickel-manganese spinel electrode was used, which was produced as follows. The following were mixed with one another in a screw-top vessel:

85% LiMn_{1.5}Ni_{0.5}O₄

6% PVdF, commercially available as Kynar Flex® 2801 from Arkema Group,

6% carbon black, BET surface area 62 m²/g, commercially available as “Super P Li” from Timcal,

3% graphite, commercially available as KS6 from Timcal.

While stirring, a sufficient amount of N-methylpyrrolidone was added to obtain a viscous paste free of lumps. The mixture was stirred for 16 hours.

Then the paste thus obtained was knife-coated onto 20 μm-thick aluminum foil and dried in a vacuum drying cabinet at 120° C. for 16 hours. The thickness of the coating after drying was 30 μm. Subsequently, circular disk-shaped segments were punched out, diameter: 12 mm.

Anode (B.1): the following were mixed with one another in a screw-top vessel:

91% graphite, ConocoPhillips C5

6% PVdF, commercially available as Kynar Flex® 2801 from Arkema Group,

3% carbon black, BET surface area 62 m²/g, commercially available as “Super P Li” from Timcal.

While stirring, a sufficient amount of N-methylpyrrolidone was added to obtain a viscous paste free of lumps. The mixture was stirred for 16 hours.

Then the paste thus obtained was knife-coated onto 20 μm-thick copper foil and dried in a vacuum drying cabinet at 120° C. for 16 hours. The thickness of the coating after drying was 35 μm. Subsequently, circular disk-shaped segments were punched out, diameter: 12 mm.

The following electrolyte was always used:

1 M solution of LiPF₆ in anhydrous ethylene carbonate-ethyl methyl carbonate mixture (proportions by weight 1:1)

### II.1 Production of an Inventive Electrochemical Cell EC.1 and Testing

The inventive separator (S.1) produced according to I.1 was used as a separator and, for this purpose, electrolyte was dripped onto it in an argon-filled glovebox and it was positioned between a cathode (A.1) and an anode (B.1) such that both the anode and the cathode had direct contact with the separator. The electrolyte was added to obtain inventive electrochemical cell EC.1. The electrochemical analysis was effected between 4.25 V and 4.8 V in three-electrode Swagelok cells.

The first two cycles were run at 0.2 C rate for the purpose of forming; cycles no. 3 to no. 50 were cycled at 1 C rate, followed again by 2 cycles at 0.2 C rate, followed by 48 cycles at 1 C rate, etc. The charging and discharging of the cell was performed with the aid of a “MACCOR Battery Tester” at room temperature.

It was found that the battery capacity remained very stable over the course of the repeated charging and discharging.

### II.2 to II.8 Production of Electrochemical Cells EC.2, EC.3, EC.4, EC.5, and C-EC.6, C-EC.7 and C-EC.8, and Testing

Analogously to Example II.1, separators S.2, S.3, S.4, S.5, and C-S.6, C-S.7 and C-S.8, were used to produce electrochemical cells EC.2, EC.3, EC.4, EC.5, and C-EC.6, C-EC.7 and C-EC.8, and they were tested correspondingly.

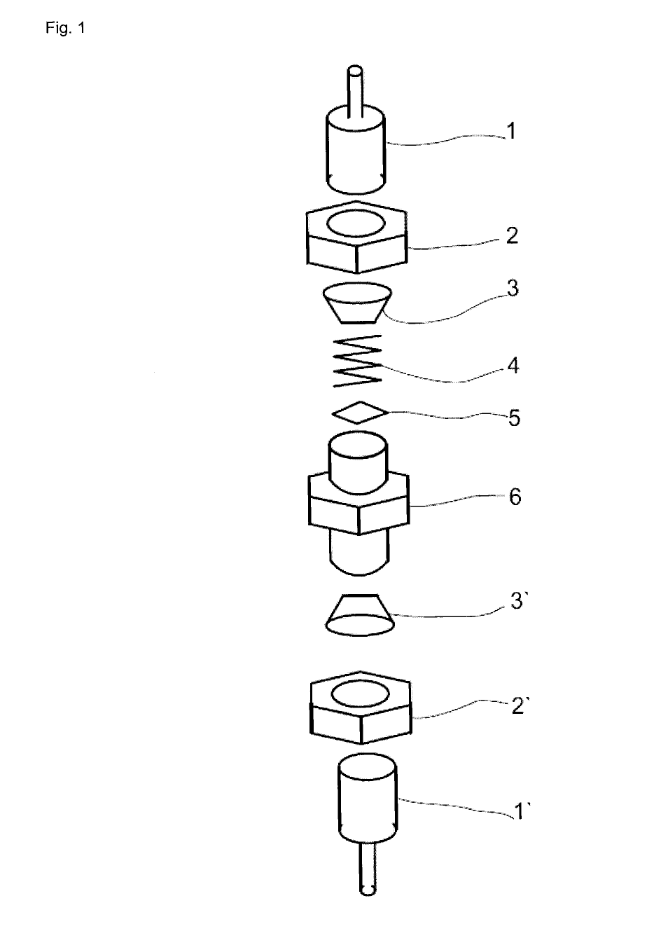

FIG. 1 shows the schematic structure of a dismantled electrochemical cell for testing of inventive and noninventive separators.

The annotations in FIG. 1 mean:
1, 1′ die
2, 2′ nut
3, 3′ sealing ring—two in each case; the second, somewhat smaller sealing ring in each case is not shown here
4 spiral spring
5 output conductor made from nickel
6 housing

Results:

Electrochemical cell EC.1 was charged and discharged in a very stable manner over 150 cycles and lost only 8% of the start capacity after 130 cycles.

Electrochemical cell EC.2 was charged and discharged in a very stable manner over 150 cycles and did not lose any start capacity after 130 cycles.

Electrochemical cell EC.3 was charged and discharged in a very stable manner over 150 cycles and lost only 26% of the start capacity after 130 cycles.

Electrochemical cell EC.4 was charged and discharged in a very stable manner over 150 cycles and lost only 15% of the start capacity after 130 cycles.

Electrochemical cell EC.5 was charged and discharged in a very stable manner over 150 cycles and lost only 17% of the start capacity after 130 cycles.

Electrochemical cells C-EC.6 from the comparative example degraded relatively quickly and lost 42% of the start capacity after about 130 cycles.

Electrochemical cells C-EC.7 from the comparative example degraded relatively quickly and lost 41% of the start capacity after about 130 cycles.

Electrochemical cell C-EC.8 from the comparative example was charged and discharged in a very stable manner over 150 cycles and lost only about 4% of the start capacity after 130 cycles.

1. An electrochemical cell comprising
(A) at least one cathode comprising at least one lithium ion-containing transition metal compound,
(B) at least one anode,
(C) at least one layer comprising
(a) at least one lithium- and oxygen-containing, electrochemically active transition metal compound, and
(b) optionally at least one binder, and
(D) at least one electrically nonconductive, porous and ion-pervious layer positioned between cathode (A) and layer (C), and at least one electrically nonconductive, porous and ion-pervious layer positioned between anode (B) and layer (C).

2. The electrochemical cell according to claim 1, wherein lithium ion-containing transition metal compound is selected from manganese-containing spinels and manganese-containing transition metal oxides with layer structure.

3. The electrochemical cell according to claim 1 or 2, wherein anode (B) is selected from anodes composed of carbon and anodes comprising Sn or Si.

4. The electrochemical cell according to any of claims 1 to 3, wherein the lithium- and oxygen-containing, electrochemically active transition metal compound from layer (C) is a particulate material.

5. The electrochemical cell according to any of claims 1 to 4, wherein the lithium- and oxygen-containing, electrochemically active transition metal compound from layer (C) is a compound selected from the group consisting of lithium titanates of the formula Li₄₊ₓTi₅O₁₂ where x is a numerical value from >0 to 3, lithium iron phosphate, lithium nickel cobalt manganese oxides, lithium nickel cobalt aluminum oxides, lithium manganese oxides and mixtures thereof.

6. The electrochemical cell according to any of claims 1 to 5, wherein the lithium- and oxygen-containing, electrochemically active transition metal compound from layer (C) is a compound which, in an electrochemical cell, has a potential difference between 1 and 5 V with respect to Li/Li⁺.

7. The electrochemical cell according to any of claims 1 to 6, wherein the lithium- and oxygen-containing, electrochemically active transition metal compound from layer (C) is a lithium titanate of the formula Li₄₊ₓTi₅O₁₂ in which x is a numerical value from >0 to 3.

8. The electrochemical cell according to any of claims 1 to 7, wherein layer (C) comprises a binder (b) selected from the group of polymers consisting of styrene-butadiene rubber and fluorinated (co)polymers.

9. The electrochemical cell according to any of claims 1 to 8, wherein layer (C) has a mean thickness in the range from 1 to 50 μm.

10. The use of electrochemical cells according to any of claims 1 to 9 in lithium ion batteries.

11. A lithium ion battery comprising at least one electrochemical cell according to any of claims 1 to 9.

12. The use of electrochemical cells according to any of claims 1 to 9 in automobiles, bicycles operated by electric motor, aircraft, ships or stationary energy stores.

13. A process for producing an electrochemical cell according to any of claims 7 to 9, comprising
(A) at least one cathode comprising at least one lithium ion-containing transition metal compound,
(B) at least one anode,
(C) at least one layer comprising
(a) at least one lithium titanate of the formula Li₄₊ₓTi₅O₁₂ in which x is a numerical value from >0 to 3, and
(b) optionally at least one binder, and
(D) at least one electrically nonconductive, porous and ion-pervious layer positioned between cathode (A) and layer (C), and at least one electrically nonconductive, porous and ion-pervious layer positioned between anode (B) and layer (C),
comprising, as one of the process steps, the lithiation of Li₄Ti₅O₁₂ by a process step selected from the group of process steps consisting of:
(i) electrochemical reduction of Li₄Ti₅O₁₂ against a lithium anode,
(ii) reaction of Li₄Ti₅O₁₂ with elemental lithium, and
(iii) reaction of Li₄Ti₅O₁₂ with a lithium alkyl or lithium aryl.

14. A flat separator of layered structure for the separation of a cathode and an anode in an electrochemical cell, comprising
(C) at least one layer comprising
(a) at least one lithium- and oxygen-containing, electrochemically active transition metal compound, and
(b) optionally at least one binder, and
(D) two layers which are aligned parallel to one another and are electrically nonconductive, porous and ion-pervious, layer (C) being between the two layers (D).
